(19) United States
(12) Patent Application Publication
(10) Pub. No.: US 2026/0090941 A1
(43) Pub. Date: Apr. 2, 2026

(54) Container Shadow Box Frame for Housing Ashes and Personal Items of Deceased Person or Pet

(71) Applicant: Gary Planamento, Stormville, NY (US)

(72) Inventor: Gary Planamento, Stormville, NY (US)

(21) Appl. No.: 19/345,443

(22) Filed: Sep. 30, 2025

Related U.S. Application Data
(60) Provisional application No. 63/701,340, filed on Sep. 30, 2024.

(51) Int. Cl. A61G 17/08; B65D 6/02; B65D 25/06; B65D 25/54

(52) U.S. Cl. CPC A61G 17/08; B65D 9/06; B65D 25/06; B65D 25/54; B65D 2203/12

(57) ABSTRACT

A shadow box frame container is disclosed, providing a shadow box for housing the ashes of a deceased person or pet, as well as personal items of the deceased person or pet. The shadow box frame container may be hung up on a wall to display personal items, such as photos, a collage, or artwork. The shadow box frame container may include a recorder and speaker that can record and play a thirty second recording multiple times.

This application claims the benefit of U.S. Provisional Patent Application Ser. No. 63/701,340, (GP24-001 (PR)), filed on Sep. 30, 2024, which is herein incorporated by reference in its entirety.

### BACKGROUND

### Field

The present disclosure relates generally to a shadow box frame container for housing the ashes of a deceased person or pet, as well as personal items or photos or art.

### Background

Traditionally, when a person or pet is cremated, the ashes of the deceased person or pet are put into a mausoleum, a wooden box or casket, or an urn or decorative vase.

### SUMMARY

The present disclosure seeks to provide a shadow box frame container for housing the ashes of a deceased person or pet, as well as personal items or photos or art.

Accordingly, it is an object of one or more embodiments of the present disclosure to provide a shadow box frame container for displaying any size photo, collage, or artwork of a deceased person or pet and that can be set on a shelf or table or hung up on a wall.

It is a further object of the disclosure to provide a shadow box frame container for housing the ashes of a deceased person or pet that includes an audio device that can record and play a message or musical snippet.

The above and other objects of the present disclosure may be accomplished in the following manner. A shadow box frame container for housing the ashes of a deceased person or pet, as well as other personal items, is disclosed. The shadow box frame container includes a frame at a front of the container, a cover at a top of the container, an optional audio device, and a removable panel inside the container, separating a forward compartment from a rear compartment.

The objects of the disclosure are further achieved by providing a check list of things to be done before a person or pet dies, as well as a simple handwritten will.

The object of this disclosure includes its variants, and its alternative embodiments, independently of its applications or processes it may be applied to.

### BRIEF DESCRIPTION OF THE DRAWINGS

The present disclosure will be more clearly understood from the following description taken in conjunction with the accompanying drawings in which like reference numerals designate similar or corresponding elements, regions, and portions and in which:

FIG. 1 shows a perspective view of the shadow box frame container, of the present disclosure.

FIG. 2 shows a detailed view of the top of the shadow box frame container with, for example, two slots for a removable panel to be placed into, separating the ashes from the personal items of a deceased person or pet.

FIG. 3 shows a side view of the shadow box frame container with, for example, two slots for a removable wooden panel to be placed into, separating the ashes from the personal items of a deceased person or pet.

FIG. 4 shows a top view of the cover, including recorder and play buttons of, for example, a thirty second audio device of the present disclosure.

FIGS. 5A, 5B, and 5C show a top, side, and bottom view of, for example, the audio device, of the present disclosure.

### DETAILED DESCRIPTION

The present disclosure discloses a shadow box frame container for housing the ashes of a deceased person or pet, as well as other personal items. The shadow box frame container may be put on a shelf or on a table or hung up on a wall to display such items as photos, a collage, or artwork. The shadow box frame container includes a cover and an audio device, which may comprise a recorder and speaker that can record and play, for example, a thirty second recording. The recorder may have a movable top button to press to record the thirty second recording and can be run by a watch battery.

The shadow box frame container may comprise a second set of slots on each side of a rear compartment, into which a removable panel can be inserted, when moving it from a first set of slots. This allows for more room for personal items in a forward compartment, representing who a person or pet was or how they wished to be remembered. The rear compartment of the shadow box frame container may house the ashes of that person or pet, as well as personal items. The forward compartment can hold personal items, such as photos, a collage, or artwork, which would be visible through the front of the shadow box frame container.

The audio device may comprise an interface with a record and play button. Selecting ‘record’ can record over any previous recording that exists on the audio device. The thirty second sound bite can be a recording of a person's voice saying a phrase, song, or poem, or other audio such as a part of a favorite song.

The shadow box frame container may serve as a memorial and, for example, the American flag may be displayed for those who were in the military. It can also provide a check list of things to be done before relinquishing life, as well as a simple will, for one to put wishes down on paper in personal handwriting.

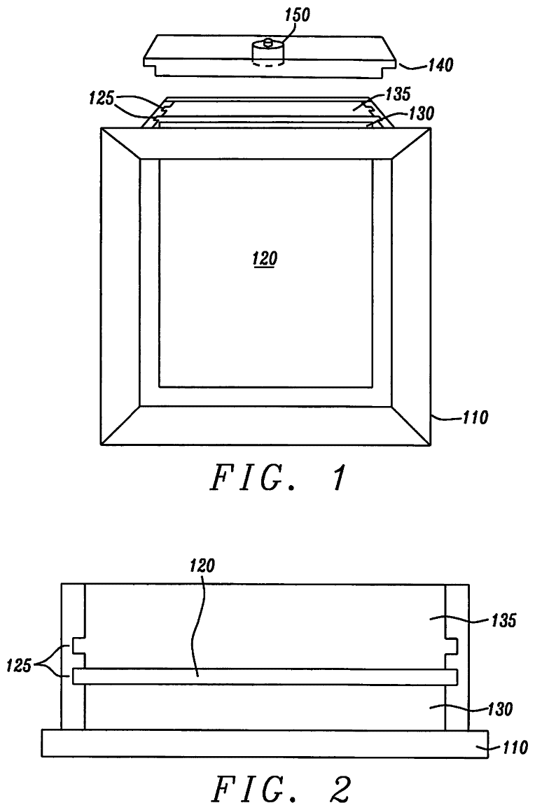

FIG. 1 shows a perspective view of the shadow box frame container, of the present disclosure. Frame 110, attached to the front of the shadow box frame container, can display personal items, such as photos, a collage, or artwork. Removable panel 120 may be placed in slots 125, in a forward or in a rear position, separating forward compartment 130 from rear compartment 135. Cover 140 is attached to the top of the shadow box frame container, and an optional audio device includes recorder 150, that may be used to record a person's voice or musical snippet. The frame, container, removable panel, and cover may be made of, for example, wood.

FIG. 2 shows a detailed view of the top of the shadow box frame container with, for example, two sets of slots 125 inside of the container, for removable panel 120 to be placed into, separating the ashes from the personal items of a deceased person or pet. The rear compartment 135 is on one side of the removable panel, and the forward compartment 130 is on the other side. The removable panel may be, for example, 15″ in length and in height.

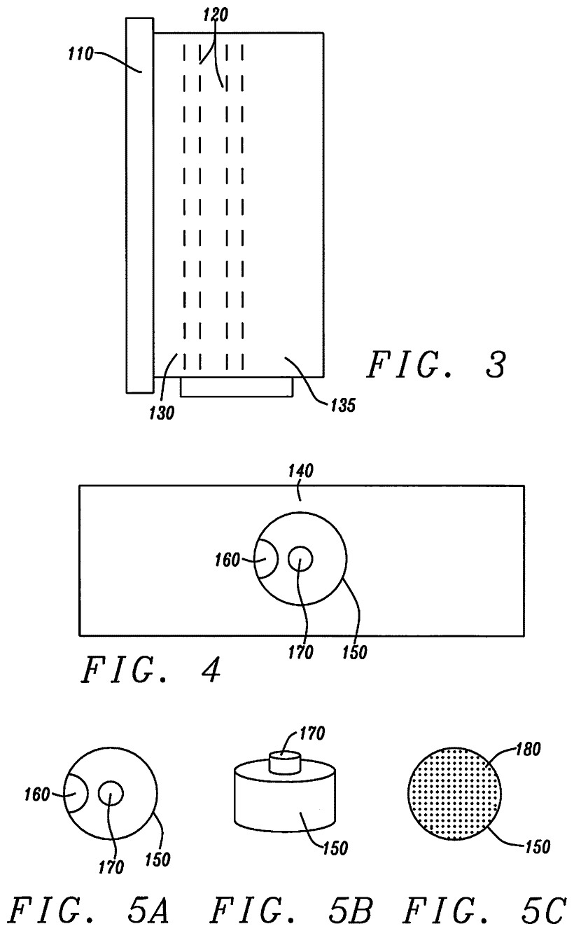

FIG. 3 shows a side view of the shadow box frame container with two sets of slots 125 for the removable panel 120 to be placed into, separating the ashes from the personal items of a deceased person or pet. Frame 110 is attached to the front of forward compartment 130. The removable panel is shown in a first set of slots in FIG. 2, separating the forward compartment from rear compartment 135. The frame may include a transparent cover, like a traditional picture frame. Alternately, the frame can be left open.

FIG. 4 shows a top view of the cover 140, and an audio device with record and play buttons of, for example, a thirty second sound recorder. The cover sits on top of the container. Recorder 150 includes recorder button 160 and play button 170, where the recorder button may be a movable button.

FIGS. 5A, 5B, and 5C show a top, side, and bottom view of the audio device of the present disclosure. The audio device includes an interface with recorder 150, recorder button 160, play button 170, and speaker 180, and can record and play thirty second recording multiple times. Speaker 180 is located on the bottom of recorder 150. Cover 140 is attached to the container frame by sitting inside slots. The recorder is attached to the cover by dropping the recorder in a separate slot. A rubber band may be used to keep the recorder in place.

The container shadow box frame construction may include USA grade pine wood. Typical dimensions include a cover that is, for example, 18″ in length and 3¼″ in width, a frame that is, for example, 19½″ in length and 19½″ in height, a removable panel that is, for example, 15″ in length and 15″ in height, and a recorder that is, for example, 1¾″ in diameter and 1″ in height. A primary aspect of the invention is that the box is narrower from front to back than from side to side, so that the personal items of a deceased person or pet may be displayed from the front of the box.

The main advantage of one or more embodiments of the present disclosure includes providing a shadow box frame container that can house the ashes of a deceased person or pet, as well as personal items or photos or art of the deceased person or pet. The container shadow box frame can be put on a shelf or on a table or hung up on a wall. It may also record thirty seconds of a personal message or musical snippet.

While particular embodiments of the present disclosure have been illustrated and described, it will be understood by those skilled in the art that various changes in form and details may be made without departing from the spirit and scope of the invention.

What is claimed is:

1. A shadow box frame container for housing the ashes of a deceased person or pet, as well as personal items of the deceased person or pet, comprising:
a frame, at a front of the shadow box frame container;
a cover, at a top of the shadow box frame container; and
a removable panel inside of the shadow box frame container, separating a forward compartment from a rear compartment.

2. The shadow box frame container of claim 1, wherein the forward compartment is configured to display the personal items of the deceased person or pet.

3. The shadow box frame container of claim 1, wherein the rear compartment is configured to house the ashes of the deceased person or pet.

4. The shadow box frame container of claim 1, wherein the container has a first pair of slots for the removable panel to be placed into.

5. The shadow box frame container of claim 4, further comprising a second set of slots.

6. The shadow box frame container of claim 1, wherein the frame, container, removable panel, and cover are made of wood.

7. The shadow box frame container of claim 1, further comprising an audio device, comprising a recorder button, a play button, and a speaker.

8. The shadow box frame container of claim 7, wherein the audio device is configured to record a message or musical snippet.

9. The shadow box frame container of claim 7, wherein the audio device is configured to record over a previous recording that exists on the audio device, multiple times.

10. The shadow box frame container of claim 7, wherein the audio device is powered by a watch battery.

11. The shadow box frame container of claim 1, wherein the container is configured to rest on a shelf or on a table or be hung up on a wall.

12. The shadow box frame container of claim 1, wherein the container is configured to hold a check list of things to be done before relinquishing life, as well as a simple will.

13. The shadow box frame container of claim 1, wherein a portion of the cover sits inside the frame.

14. The shadow box frame container of claim 1, wherein the recorder is integrated with the cover.

15. The shadow box frame container of claim 1, wherein the container materials comprise pine wood and glass.

16. The shadow box frame container of claim 1, wherein the frame further comprises a transparent cover.
